(19) United States
(12) Patent Application Publication
(10) Pub. No.: US 2004/0116578 A1
(43) Pub. Date: Jun. 17, 2004

(54) Granular inorganic filler, process for producing the filler and resin compositions containing the same

(76) Inventors: Yasutaka Imanishi, Mie (JP); Tateki Arakawa, Mie (JP); Junichi Kawashima, Mie (JP); Mikio Miyaji, Mie (JP); Kazutoyo Matsumura, Osaka (JP); Tsuyoshi Hamaie, Osaka (JP); Ryohei Watanabe, Tokyo (JP); Katsuhiro Otsuka, Tokyo (JP)

Correspondence Address: WENDEROTH, LIND & PONACK, L.L.P., 2033 K STREET N. W., SUITE 800, WASHINGTON, DC, 20006-1021, US

(21) Appl. No.: 10/432,432

(22) PCT Filed: Nov. 20, 2001
(86) PCT No.: PCT/JP01/10137

(30) Foreign Application Priority Data
Nov. 24, 2000 (JP) 2000-357562
May 11, 2001 (JP) 2001-142036

(51) Int. Cl. C04B 14/04; C08K 3/34

(52) U.S. Cl. 524/445; 106/486

(57) ABSTRACT

Provided are a granular inorganic filler which is highly effective in improving the physical properties of resins and excellent in working efficiency, working atmosphere, productivity and economical efficiency, a process for producing the filler, and resin compositions excellent in mechanical properties, surface appearance, flame retardance and antiblock properties. The filler is produced by granulating a mixture comprising inorganic filler particles having a mean particle diameter of 0.01 to 20 μm and a binder in such a way as to give an apparent density of 0.1 to 3.0 g/ml and a breakage rate of 5 to 80 wt %. The resin compositions are prepared by adding the granular inorganic filler to resins.

### FIELD OF THE INVENTION

The present invention relates to a granular inorganic filler, a process for producing the said granular inorganic filler which comprises glanulating inorganic filler particles in combination with a binder, and a resin composition obtained by admixing the granular inorganic filler.

### BACKGROUND OF THE INVENTION

Various fillers are formulated in various thermoplastic and thermosetting resins as extenders, reinforcing materials, flame retardants, anti-blocking agents and the like while taking advantage of their characteristics. A great number of these resins are used in various fields from household items such as garbage bags, wash basins, and various plastic sundry articles to electric cables, automobile-related articles and home electric appliances, etc. Inorganic fillers are also known to have high effects to improve physical properties of resins when used with small average particle diameters.

In general, various resins are melted and kneaded using kneaders, mixers and the like, in combination with fillers, coloring pigments, stabilizers, dispersants, etc. to form granulated or pelletized materials. The granulated pellets are heated and melted, and molded into desired products using an injection molding machine, extruder, blow molding machine and the like.

When various inorganic fillers and resins are melted and kneaded, the smaller the average particle diameter of the inorganic filler is, the smaller the apparent density is, leading to a lowering working property in the melting and kneading. This phenomenon is attributed to internal air included in the inorganic filler. It is known in the art that the working property is improved when the apparent density is enlarged and the bulk of the inorganic filler is reduced by deaerating the internal air and further compressing to physically eliminate the internal air.

However, when artisans further attempt to improve the working property and to increase the extrusion capacity, the bulk of the inorganic filler must be further reduced. Thus, there has been a problem in that although it is possible for the inorganic filler to be more firmly solidified, inferior dispersion of the inorganic filler occurs in the resultant molded article of the resin composition, no physical property improvement effect is obtained, and the inorganic filler which cannot disperse well makes the surface appearance of the molded article worse.

It is possible to reduce the inorganic filler volume by physically carrying out a process such as compression to extract the internal air. However, when the formulation amount is increased, it is necessary that mixing work with the resins is carried out for a long period of time in a mixer which performs the mixing work using agitation blades such as the Henschel type mixer and super mixer. Even if the filler is reduced in volume, when undergoing shearing stress of the agitation blades for a long period of time, the filler includes air again and the internal air amount is increased, leading to a loss in the improvement effect of the kneading work and a reduction in production efficiency. Also, there has been a problem in that even if the filler is reduced in its volume, when the inorganic filler is transferred from a paper bag or freight conveyor to a hopper or mixing machine, powdered dust is generated, which worsens the working environment.

As is obvious from the above issues and concern described in the conventional art, the concern is to provide an inorganic filler which is excellent in stress durability from the outside at least until the stage of melting and kneading (for example, a filler unlikely to break even when undergoing stress by the agitation blades of a mixer at the premixing stage), improves productivity in melting and kneading work of the resin, gives no harmful effect on the desired final product, and is not likely to produce powdered dust and can also improve the working environment.

### SUMMARY OF THE INVENTION

An object of the present invention is to provide solutions to the above problems, that is, to provide a granular inorganic filler which is excellent in durability with no productivity reduction in the melt-kneading work of resins, etc. even when undergoing shearing stress by agitation blades of mixers, said inorganic filler being readily dispersible in a resin composition, and further capable of improving the working environment with remarkably restricted formation of powdered dust; a process for producing the same; and a resin composition containing the granular inorganic filler.

As a result of intensive researches to solve the aforementioned drawbacks, the present inventors have succeeded in finding that a granular inorganic filler containing 80% or more inorganic filler particles can be produced at low cost when inorganic filler particles of which the average primary particle diameter is 0.01 to 20 μm are granulated in combination with a binder into granular form products having an apparent density of 0.1 to 3.0 g/ml, and further that the granular inorganic filler of which the destruction rate is 5 to 80% by weight is (1) highly durable against external stress, (2) hardly breakable even with agitation blades of mixers, (3) capable of improving the melt-kneading workability of resins, (4) readily performable in pneumatic transportation, (5) unlikely to produce powdered dust and (6) capable of ameliorating the working environment. Thus, the present inventors have completed the invention.

The present invention provides (a) a granular inorganic filler made up of inorganic filler particles having an average primary particle diameter ranging from 0.01 to 20 μm in combination with a binder, said granular inorganic filler having an apparent density ranging from 0.1 to 3.0 g/ml and a destruction rate ranging from 5 to 80% by weight, (b) a process for producing the same, and (c) a resin composition containing the said granular inorganic filler.

The present invention also relates to a granular inorganic filler made up of inorganic filler particles of which the average primary particle diameter is 0.01 to 20 μm in combination with a binder, said granular inorganic filler having an apparent density of 0.1 to 3.0 g/ml and a destruction rate of 5 to 80% by weight, and a process for producing the same as well as a resin composition containing the granular inorganic filler.

The invention also provides (1) a process for producing a granular inorganic filler, which comprises adding a wetting agent (or moisturizing agent) to inorganic filler particles and a binder to form a mixture, processing the resultant mixture to form a granular product, and then drying the product, and (2) a process for producing the granular inorganic filler, which comprises adding a wetting agent to inorganic filler particles, a binder and a dispersing agent to form a mixture, processing the resultant mixture to form a granular product, and then drying the product; The production processes include the steps of (a) admixing a wetting agent while stirring an inorganic filler particle-binder mix, followed by molding, and (b) admixing a wetting agent while stirring an inorganic filler particle, binder and dispersing agent mix, followed by molding.

Further, the invention provides a resin composition comprising the said granular inorganic filler in a resin having a main ingredient selected from the group consisting of thermoplastic resins, thermosetting resins and formulations thereof.

The above objectives and other objectives, features, advantages, and aspects of the present invention are readily apparent to those skilled in the art from the following disclosures. It should be understood, however, that the description of the specification including the following best mode of carrying out the invention, examples, etc. is illustrating preferred embodiments of the present invention and given only for explanation thereof. It will become apparent to the skilled in the art that a great number of variations and/or alterations (or modifications) of this invention may be made based on knowledge from the disclosure in the following parts and other parts of the specification without departing from the spirit and scope thereof as disclosed herein.

### BEST MODE FOR CARRYING OUT THE INVENTION

The granular inorganic fillers of the invention are composed of inorganic filler particles of which the average primary particle diameter is 0.01 to 20 μm, and a binder, and have an apparent density of 0.1 to 3.0 g/ml and a destruction rate of 5 to 80% by weight. The inorganic filler particles used herein may include various materials such as reinforcing materials and flame retardants as described below. Whenever their primary particle diameters are within the above range, the inventive fillers will be greatly effective in improving physical properties owned by resin molded articles containing these filler particles. Further, when their average primary particle diameter range is within the range of 0.1 to 3 μm, the inventive fillers are far superior in the improving actions. For instance, in the case of talc particles used as the reinforcing materials, when their average primary particle diameter is within the range of 0.1 to 10 μm, preferably 1 to 3 μm, they have more superior actions on increasing strength properties (such as rigidity, tensile strength and impact strength) possessed by resin molded articles, and on controlling shrinkage of the resin molded articles after molding.

When the apparent density is less than the above range, production efficiency of the resin molded articles will be reduced. When the destruction rate is more than the above range, the granules will disintegrate easily during storage or transport. And when the destruction rate is less than the above range, the granules are unlikely to disintegrate even if molded with the resin, but likely to remain in the resin molded article as undispersed particles or agglomerated particles. A more preferable range of the apparent density is 0.7 to 2.0 g/ml. The preferable range of the destruction rate varies depending on the types of inorganic filler particles, and for example, is 5 to 60% by weight in the case of talc particles, 5 to 40% by weight in the case of magnesium hydroxide, and from 30 to 80% by weight in the case of silica particles. The apparent density and the destruction rate can be optionally adjusted by selecting the type and content level of the binder, or the production conditions described below.

In this invention, the apparent density and the destruction rate were obtained by the following method:

### Measurement Method of Apparent Density

1. Place a sample on a sieve with a sieve opening of 1.4 mm, and pass the sample through the sieve while lightly sweeping evenly with a brush.

2. Using a funnel, place the above sample in a receiver connected to an apparent density measuring apparatus as defined in JIS K5101 until in a heap.

3. Scrape away the sample at the heaped part from the inlet of the receiver, measure the weight of the sample inside the receiver, and calculate by the following equation:

Apparent Density (g/ml)=Sample Weight (g) in Receiver/Receiver Volume (ml)

### Measurement Method of Destruction Rate

1. Place 100 g of a sample into a ceramic pot of 100×100 mm, three ceramic balls of 35 g (3 cm Φ) are added as Ball mill, and pulverize with the balls at 75 rpm for 15 min.

2. Place the pulverized sample on a #60 mesh sieve, checkweigh a portion under the sieve, and calculate by the following equation:

Destruction Rate (% by weight)=[Weight under Sieve(×g)/Sample Weight (100 g)]×100

The shape of the granular inorganic filler covers a stick, cylinder, needle-like, grained, flake-like, amorphous and the like, but is not particularly limited to. The granular inorganic filler shape may be appropriately determined depending on its intended use. Its size is not particularly limited as long as it is within the above range of the apparent density. However, those smaller than resin pellets used for melting/kneading and molding are advantageous when dispersed in a melting/kneading machine or a molding machine. For instance, the granular inorganic filler has preferably an average axis length of 0.5 to 5 mm and an axis ratio of 0.3 to 3 for a stick or cylinder shape, and it is more preferable that the axis length and the axis ratio are almost the same size within an above average axis length range.

The amount of the inorganic filler particles contained in the granular inorganic filler of the invention is determined by the content amount of the binder required for retaining the destruction rate of the granular inorganic filler within a range where the characteristics of the invention are not lost. That is, when the content amount of the binder is insufficient, the destruction rate exceeds the specified upper limit required for the invention and the filler becomes fragile. Therefore, the binder is admixed at preferably 0.1 through 20%, and more preferably 0.5 through 10% by weight.

The binders used in the invention are desirably those which are highly granulable with inorganic filler granules, are colorless or near white, are inert and stable substances, and do not reduce the physical property of the resin molded article. The binder includes clay minerals exerting high caking property under wet conditions, such as bentonite, kaolin, sericite and acidic white clay (the Clay Science Society of Japan (Ed.), “Nendo Handbook” (2nd Edition), GIHODO SHUPPAN Co. Ltd., Japan, 1987; MAENO, Masahiro, “Sokoga Shiritai Nendo no Kagaku”, the Nikkan Kogyo Shinbun Ltd., Japan, Jul. 30, 1993); inorganic substances such as colloidal silica and gypsum; and organic substances such as gelatin, hide glue, lignin, cellulose, polyvinyl alcohol, starch, agarose, wax, higher fatty acids and resin powders. Bentonite is slightly colored, but inexpensive, of which the liquid limit (the water content at which a sample will begin to flow by its own weight due to softening derived from incorporation of water) is large, and of which the caking property is high. This is also excellent in granulability since it has characteristics that provide large caking properties at low moisture and high sorbability for inorganic and organic substances, as well as being non-toxic and highly stable, and has wide selectivity for resin species. Therefore, it is preferable.

The inorganic filler particles used in the invention are not particularly limited as long as they can be used in the production field of resin compositions, and include, for example, reinforcing agents, extenders, flame retardants, antimicrobial agents, conductive agents, UV absorbers, coloring agents and others. These are used alone or in combination with several types. Specifically, the reinforcing agents and extenders may include oxides such as silica, titanium oxide and alumina, complex oxides such as potassium titanium oxide, hydroxides such as calcium hydroxide, carbonates such as calcium carbonate, sulfates such as barium sulfate, calcium sulfate and Mos-hige, borates such as aluminium borate, silicates such as aluminium silicate, calcium silicate, xonotlite, talc, kaolin clay, clay, rouseki clay, mica, sepiolite, glass powders, bentonite, purified bentonite and diatomite, carbons such as carbon black, metals such as aluminium powders, burnout ash, etc. The flame retardants may include magnesium hydroxide, aluminium hydroxide, stibium oxide, phosphate esters, halo-containing phosphate esters, etc. The UV absorption materials may include ultrafine titanium oxide, ultrafine zinc oxide, etc. The antimicrobial agents (materials) may include silver, silver carriers, etc. The conductive agents may include metals such as silver, copper, nickel and tin, and compounds thereof; carriers coated therewith; carbon black; etc. The coloring agents may include metallic compounds such as titanium oxide, zinc oxide, colcothar, cadmium yellow, ferrocyanine blue and mica; carbon black; etc. Among them, talc, magnesium hydroxide, mica, titanium oxide, silica, calcium silicate and calcium carbonate are suitable for the inorganic filler particles used for the invention. Particularly, talc and magnesium hydroxide are suitable which are excellent in workability and economic efficiency.

In order to enhance affinity with the resin, the surface of the inorganic filler particle used for the invention can be treated with at least one member selected from alcohols such as trimethylol ethane, trimethylol propane and pentaerythritol, alkanol amines such as triethylamine, organic silicone compounds such as organosiloxane, higher fatty acids such as stearic acid, fatty acid metallic salts such as calcium stearate and magnesium stearate, hydrocarbon lubricants such as polyethylene wax and liquid paraffin, basic amino acids such as lysine and arginine, and coupling agents such as polyglycerine and derivatives thereof and silane coupling agents, titanate coupling agents and aluminium coupling agents.

When the dispersing agent is admixed at 0.05 to 5%, preferably 0.1 to 2% by weight in the granular inorganic filler of the invention, the dispersibility of the granular inorganic filler is enhanced in the resin molded article, and thus it is preferable. The dispersants used may be those conventionally known, and include, for example, alcohols, alkanol amines, organic silicone compounds, higher fatty acids, fatty acid metallic salts, hydrocarbon lubricants, basic amino acids, polyglycerine and derivatives thereof as described above. In the invention, one, or two or more members selected from them can be used, and using the surface-treated inorganic filler particles described above, the particles may be further granulated by adding the dispersing agent.

Various additives in addition to the dispersing agent may be admixed with the granular inorganic filler of the invention as needed within the range where the characteristics of the invention are not impaired. Such additives can include antioxidants, heavy metal inactivators, organic fillers and the like. They can be used alone or in combination of pluralities. Specifically, organic fillers include extenders such as wood power, pulp flour, plastic beads and plastic balloons, halogen flame retardants, UV absorbers such as benzophenone and benzotriazole, phenol antimicrobial and antifungal agents, anionic, cationic and nonionic antistatic agents, pigments such as phthalocyanine, quinacridone and benzidine, and azo and quinone dyes, and the like.

The granular inorganic filler of the invention can be produced by adding the wetting agent to the inorganic filler particles and the binder, and molding followed by drying. However, in the process for the production of the invention, first, the inorganic filler particles are pulverized as needed, subsequently the binder and the appropriate dispersing agent and other additives are added, and after or during the wetting agent is added thereto, the mixture is mixed by a blender or mixer. When affinity of the inorganic filler particles with the wetting agent is low, the mixture can be made by adding the wetting agent with stirring by a high peripheral velocity stirrer such as Henschel type mixer, super mixer and high speed mixer, for example, a stirrer of which the peripheral velocity is 5 m/second or more. The dispersing agent and additives can be used by dissolving or dispersing beforehand in the wetting agent. When the dispersing agent and additives are insoluble or hard to dissolve in the wetting agent, they are also used by premixing with the binder, preferably with pulverizing by a pulverizer. In order to enhance moldability of the granular inorganic filler, the above mixture can be thoroughly kneaded using a screw type mixing machine such as single screw and twin screw types, roller type mixing machine, kneader type mixing machine, high speed mixer and the like, or the wetting agent can be also added upon the kneading of the inorganic filler and the binder without adding the wetting agent upon blending. The inorganic filler particles and the binder may be classified before or after blending.

The wetting agent is added in order to enhance kneading property of the inorganic filler particles and the binder as well as adjust hardness of granules. It can be also used by premixing with the binder. The wetting agent used may include organic solvents such as acetone, plasticizers such as phthalate esters, various oils such as silicone oil and castor oil, and others. The preferable wetting agent is suitably selected from water, alcohol, and a mixture thereof which are easily handled with good working property. In particular, the most preferable wetting agent is water since the process of a volatile component upon drying will become easy. In order to obtain a specified destruction rate required for the granular inorganic filler of the invention, when water, alcohol or the mixture thereof is used as the wetting agent, the amount to be added is 10 to 150 parts by weight, preferably 30 to 150 parts by weight based on 100 parts by weight of the sum of the inorganic filler particles plus the binder (i.e., the wetting agent is added in an amount ranging from 10 to 150 parts by weight based on total inorganic filler particle+binder composition weight where the total weight of the inorganic filler particle plus the binder is set at 100 parts by weight).

Next, the mixture or kneaded mixture is granulated and molded by a screen type (such as basket and dome type) or rotation porous dice type extrusion molding machine, a compression molding machine such as a roll type or tabletting machine, a rotation pan or rotation drum type rolling molding machine, a stirrer such as a mixer, or a fluidized bed granulator to form granular products which, as needed, are then delumped using a particle size selector or delumper, and dried using a fluid dryer or band heater. Various sizes and shapes of granules can be produced under specific molding conditions and particle size regulation conditions selected depending on the intended use. For instance, when stick or cylinder particles are produced, an axis diameter is appropriately determined by changing sieve opening sizes of a screen in a screen type extrusion molding machine, and the products can be molded and delumped to cut into the desired axis diameter. The drying temperature can be a temperature at which the wetting agent evaporates or vaporizes, and a temperature of 80 to 150° C., preferably 80 to 110° C. is proper in the case of water. Also, in the invention, a classification can be carried out after drying.

The resin compositions of the invention are those where the aforementioned granular inorganic filler in combination with a resin, to which various additives are added as needed, is premixed in a stirring mixer such as a Henschel type mixer, and melt-kneaded with a single screw or twin screw extruder or kneader followed by extrusion molding and blow molding, or pelletized followed by injection molding. The resin compositions of the invention have excellent strength, flame retardance, light resistance, electric conductivity, antimicrobial properties, design properties and other properties, and can be applied across a wide range such as automobile parts in bumpers and dashboards, housing articles such as home electric appliances and office automation equipment, building materials such as wall panels and roof panels, daily goods, coatings of electric cables and the like.

The resins used for the invention are not particularly limited as long as they are those generally used in the field of resin composition, which exert thermoplastic or thermosetting properties. For instance, thermoplastic resins can include those having each a main component selected from the group consisting of polyethylene resins, polypropylene resins, polyolefin resins of ethylene-propylene copolymers, polyester resins such as polyethylene naphthalate, polyethylene terephthalate, polybutylene terephthalate and polyarylate, stylene resins such as acrylonitrile-butadiene-stylene copolymer and polystylene, aromatic resins such as polyphenylene ether, polyetheretherketone resins, polyphenylene sulfide, polyether sulfone resins, poly sulfone resins, vinyl resins such as vinyl chloride and vinyl acetate, urethane resins, nylon resins, polyimide resins, polyamideimide resins, polyether imide resins, acrylic resins, rubber resins, fluorinated resins, polyacetal resins, polycarbonate resins, etc. Multiple resins can be also used. Those which are thermosetting include those having a main component selected from the group consisting of phenol resins, urethane resins, unsaturated polyester resins and the like.

The advantageous effects or actions obtained by the invention are believed to be expressed or exerted via the following mechanisms. That is, because the binder itself used in the invention has been originally intended for use as a resin modifying agent, additive, dispersing agent, inorganic filler and the like for various resin compositions, it does not impair the actions of the inorganic filler particles to be granulated even when merely a small amount of the binder is used as a binder in the granular inorganic filler. Because the binder used in the granular inorganic filler is high in caking property and is readily impasted, it can be thoroughly kneaded with the inorganic filler particles using a wetting agent even if it is in a small amount, with the result that the kneaded mixture itself will become impasted with caking property by thoroughly kneading. Even if the wetting agent in the impasted kneaded mixture having caking property is eliminated during the step of drying, the resultant granular inorganic filler can provide durability in external stress to a certain extent, and the destruction rate can be reduced. Regulation of the durability is carried out by regulating the use amount of the binder, the use amount of the binder and the durability are in proportionately related, and thus control is possible. Therefore, it becomes possible to produce the granular inorganic filler, while regulating a certain or a given destruction rate, i.e., a degree of durability such that the melting and kneading work is not reduced, or such that the granular inorganic filler is easily redispersed into primary particles in the resin composition in the case of mixing the resins and the granular inorganic filler. Consequently, the granular inorganic filler is believed to enhance the productivity in the melting and kneading work of the resin composition, increase economic efficiency, further restrain the production of powered dust, and improve the working environment.

### EXAMPLES

The present invention is described in greater detail by the examples below, which are provided only for illustrative purposes; however, these illustrative examples should not be construed as limiting or restricting the scope of the present invention disclosed herein. All the examples were or can be practiced using standard techniques well or conventionally known to those of ordinary skill in the art unless otherwise specified.

### Example 1

Talc particles, High filler #5000PJ (3,900 g; supplied by Matsumura Sangyo, Japan) of which the average primary particle diameter was 1.8 μm and 100 g of bentonite (supplied by Hojun Co. Ltd., Japan) were mixed for 5 min using a 30 L blender, and further mixed for about 30 min while adding 1,600 g of water as the wetting agent. Then, the mixture was extruded from a screen with a sieve opening of 1.2 mm Φ and molded using a basket type screen molding machine, and products were then delumped to afford granules with a cylinder shape having a diameter of about 1.2 mm and an average axis length of about 2 mm (axis ratio 1) followed by fluidized drying at a temperature of 90° C. for one hour to yield granulated talc (Sample A).

### Example 2

The process of Example 1 was repeated to afford granulated talc (Sample B) except that talc particles (3,800 g) and bentonite (200 g) used in Example 1, respectively, were employed.

### Example 3

The process of Example 1 was repeated to afford granulated talc (Sample C) except that talc particles (3,600 g) and bentonite (400 g) used in Example 1, respectively, were employed.

### Example 4

The process of Example 1 was repeated to afford granulated talc (Sample D) except that commercially available trimethylol propane was added as the dispersing agent so as to be 0.2% by weight based on the weight of the talc particles used in Example 1.

### Example 5

The process of Example 1 was repeated to afford granulated talc (Sample E) except that commercially available trimethylol propane was added as the dispersing agent so as to be 0.4% by weight based on the weight of the talc particles used in Example 1.

### Example 6

The process of Example 2 was repeated to afford granulated talc (Sample F) except that a polyglycerine derivative (Plenlizer-MK600; Ajinomoto Fine Techno Co. Inc., Japan) was added as the dispersing agent so as to be 1% by weight based on the weight of the talc particles used in Example 1 and the polyglycerine derivative was dispersed in water as the wetting agent.

### Example 7

Magnesium hydroxide particles (3,800 g, SX-30MS; Nitto Funka Kogyo KK, Japan) of which the average primary particle diameter was 0.84 μm, 200 g of bentonite (Hojun Co. Ltd., Japan) and 40 g of polyglycerine derivative (Plenlizer-MK600; Ajinomoto Fine Techno Co. Inc.) were mixed using a 30 L blender, and further mixed while adding 1,600 g of water and 600 g of methyl alcohol as the wetting agents. Then, the mixture was extruded from a screen with a sieve opening of 1.2 mm Φ and molded using a basket type screen molding machine, and prudocts were delumped to afford granular materials having a cylinder shape with a diameter of about 1.2 mm and an average length of about 2 mm (axis ratio 1) followed by fluidized drying at a temperature of 90° C. for one hour to yield granules (Sample G).

### Example 8

Magnesium hydroxide particles (1,880 g, Finemag MO-T; TMG, Japan) of which the average primary particle diameter was 1.58 g m, 100 g of bentonite (Hojun Co. Ltd., Japan) and 20 g of polyglycerine derivative (Plenlizer-MK600; Ajinomoto Fine Techno Co. Inc.) were agitated for 30 seconds at a main axis rotational frequency of 1900 rpm (peripheral velocity 20 m/sec) using a Henschel type 10 L mixer, and further agitated for 6 min while adding 900 g of water as the wetting agent, and mixed. Then, the mixture was extruded from a screen with a sieve opening of 1.2 mm Φ and molded using a dome type screen molding machine, and products were then delumped to afford granular materials having a cylinder shape with a diameter of about 1.2 mm and an average length of about 2 mm (axis ratio 1), followed by drying in the same fashion as in Example 7 to yield granules (Sample H).

### Example 9

Magnesium hydroxide particles (1,880 g, Finemag SN-L; TMG) of which the average primary particle diameter was 1.32 μm, 100 g of bentonite (Hojun Co. Ltd.) and 20 g of polyglycerine derivative (Plenlizer-MK600; Ajinomoto Fine Techno Co. Inc.) were agitated for 30 seconds at a main axis rotational frequency of 1900 rpm (peripheral velocity 20 m/sec) using a Henschel type 10 L mixer, and further agitated for 2 min while adding 800 g of water as the wetting agent, and mixed. Then, the mixture was molded followed by delumping and drying in the same fashion as in Example 8 to yield granules (Sample I).

### Example 10

Commercially available magnesium hydroxide particles (1,880 g, Kisuma 5A; Kyowa Chemical Industry Co., Ltd., Japan) of which the average primary particle diameter was 1.41 μm, 100 g of bentonite (Hojun Co. Ltd.) and 20 g of polyglycerine derivative (Plenlizer-MK600; Ajinomoto Fine Techno Co. Inc.) were agitated for 30 seconds at a main axis rotational frequency of 1900 rpm (peripheral velocity 20 m/sec) using a Henschel type 10 L mixer, and further agitated for 60 min while adding 800 g of water as the wetting agent, and mixed. Then, the mixture was molded followed by delumping and drying in the same manner as in Example 8 to yield granules (Sample J).

### Example 11

Commercially available silica (957 g) of which the average primary particle diameter was 5.47 μm and 30 g of bentonite (Hojun Co. Ltd.) were agitated for 30 seconds at a main axis rotational frequency of 2920 rpm (peripheral velocity 31 m/sec) using a Henschel type 10 L mixer, and a mixed solution of water (800 g) and surfactant (13 g, Air Roll CT-1L; Toho Chemical Industry Co., Ltd., Japan) was added and mixed as the wetting agent, with further agitating for 45 min. Then, the mixture was molded followed by delumping and drying in the same manner as in Example 8 to yield granules (Sample K).

### Example 12

Commercially available silica (960 g) of which the average primary particle diameter was 5.47 μm and 30 g of bentonite (Hojun Co. Ltd.) were agitated for 30 seconds at a main axis rotational frequency of 3380 rpm (peripheral velocity 36 m/sec) using a Henschel type 10 L mixer, and a mixed solution of water (900 g) and surfactant (10 g, Air Roll CT-1L; Toho Chemical Industry Co., Ltd.) was added and mixed as the wetting agent, with further agitating for 30 min. Then, the mixture was molded followed by delumping and drying in the same manner as in Example 8 to yield granules (Sample L).

### Comparative Example 1

The talc particles used in Example 1 were used as the comparative example without further treatment (Sample a).

### Comparative Example 2

The talc particles (5,000 g) used in Example 1 were deaerated in vacuum using a bulk gravity increasing machine (Kurivac; Kurimoto Ltd.), which were then compressed using a roll compression granulator (Roller Compactor; Kurimoto Ltd.) to produce compressed talc (Sample b).

### Comparative Example 3

The magnesium hydroxide particles used in Example 7 were used as the comparative example without further treatment (Sample c).

### Comparative Example 4

The magnesium hydroxide particles used in Example 8 were used as the comparative example without further treatment (Sample d).

### Comparative Example 5

The magnesium hydroxide particles used in Example 9 were used as the comparative example without further treatment (Sample e).

### Comparative Example 6

The magnesium hydroxide particles used in Example 10 were used as the comparative example without further treatment (Sample f).

### Comparative Example 7

The silica particles used in Example 11 were used as the comparative example without further treatment (Sample g).

### Evaluation 1

Measurement of apparent density and destruction rate

The apparent density and destruction rate of Samples A through L obtained in Example 1 through 12 and Samples a through g obtained in Comparative examples 1 through 7 were measured by the methods described above. The results are shown in Table 1. Conventional inorganic filler particles are high in the destruction rate and low in the apparent density. Also, physically deaerated and compressed talc cannot obtain a destruction rate of 80% or less desired in the invention.

TABLE 1

| | | Inorganic | | | | |
|---|---|---|---|---|---|---|
| | | filler | Content (wt %) | | | |
| | | Fine particle | | Dispersing | Apparent | Destruction |
| | | material | Binder | agent | density (g/ml) | rate (%) |
| Example 1 | Sample A | Talc | 2.5 | 0.0 | 0.88 | 47 |
| Example 2 | Sample B | Talc | 5.0 | 0.0 | 0.88 | 30 |
| Example 3 | Sample C | Talc | 10.0 | 0.0 | 0.88 | 11 |
| Example 4 | Sample D | Talc | 5.0 | 0.2 | 0.88 | 22 |
| Example 5 | Sample E | Talc | 5.0 | 0.4 | 0.88 | 19 |
| Example 6 | Sample F | Talc | 5.0 | 1.0 | 0.88 | 30 |
| Example 7 | Sample G | Mg(OH)₂ | 5.0 | 1.0 | 0.84 | 25 |
| Example 8 | Sample H | Mg(OH)₂ | 5.0 | 1.0 | 0.63 | 9 |
| Example 9 | Sample I | Mg(OH)₂ | 5.0 | 1.0 | 0.67 | 15 |
| Example 10 | Sample J | Mg(OH)₂ | 5.0 | 1.0 | 0.67 | 8 |
| Example 11 | Sample K | SiO₂ | 3.0 | 1.3 | 0.32 | 57 |
| Example 12 | Sample L | SiO₂ | 3.0 | 1.0 | 0.31 | 67 |
| Comparative | Sample a | Talc | 0.0 | 0.0 | 0.12 | 100 |
| Example 1 | | | | | | |
| Comparative | Sample b | Talc | 0.0 | 0.0 | 0.78 | 85 |
| Example 2 | | | | | | |
| Comparative | Sample c | Mg(OH)₂ | 0.0 | 0.0 | 0.26 | 100 |
| Example 3 | | | | | | |
| Comparative | Sample d | Mg(OH)₂ | 0.0 | 0.0 | 0.37 | 100 |
| Example 4 | | | | | | |
| Comparative | Sample e | Mg(OH)₂ | 0.0 | 0.0 | 0.38 | 100 |
| Example 5 | | | | | | |
| Comparative | Sample f | Mg(OH)₂ | 0.0 | 0.0 | 0.37 | 100 |
| Example 6 | | | | | | |
| Comparative | Sample g | SiO₂ | 0.0 | 0.0 | 0.20 | 100 |
| Example 7 | | | | | | |

### Evaluation 2

### Evaluation of Production Amounts

Each of Samples A through L obtained in Example 1 to 12 and Samples a through g obtained in Comparative examples 1 through 7 was admixed with commercially available polypropylene pellets (block copolymer MFR=10), and mixed homogeneously with a Henschel type mixer. Each blend was then melt-kneaded using a twin screw extruder (PCM-30 type; Ikegai Ltd., Japan), and molded into pellets containing talc particles at 20% by weight, pellets containing magnesium hydroxide particles at 55% by weight, or pellets containing silica particles at 10% by weight. The production amount was measured as a discharged amount per hour. The results are shown in Table 2.

### Evaluation 3

### Evaluation of Dispersibility

The above pellets (10 g) were sandwiched between two iron sheets of which the thickness was 3 mm, preheated with a press machine heated at 230° C. for 2 min, and pressurized at 100 kg/cm² for one min. Then, two iron sheets were removed from the press machine, switched to another press machine cooled with water at room temperature, and cooled by pressurizing at 100 kg/cm² for 3 min. The pellets became a disc sheet with a thickness of 0.5 mm between two iron sheets. The resultant sheets were visually observed, and evaluated as a circle, triangle and cross in sequence with a good dispersed condition. The results are shown in Table 2.

TABLE 2

| | | Inorganic filler | Production | |
|---|---|---|---|---|
| | | Fine particle | amount | |
| | | material | (kg/hr) | Dispersibility |
| Example 1 | Sample A | Talc | 16 | ◯ |
| Example 2 | Sample B | Talc | 16 | ◯ |
| Example 3 | Sample C | Talc | 17 | ◯ |
| Example 4 | Sample D | Talc | 16 | ◯ |
| Example 5 | Sample E | Talc | 16 | ◯ |
| Example 6 | Sample F | Talc | 15 | ◯ |
| Example 7 | Sample G | Mg(OH)₂ | 14 | ◯ |
| Example 8 | Sample H | Mg(OH)₂ | 13 | ◯ |
| Example 9 | Sample I | Mg(OH)₂ | 13 | ◯ |
| Example 10 | Sample J | Mg(OH)₂ | 13 | ◯ |
| Example 11 | Sample K | SiO₂ | 13 | ◯ |
| Example 12 | Sample L | SiO₂ | 15 | ◯ |
| Comparative | Sample a | Talc | 6 | ◯ |
| Example 1 | | | | |
| Comparative | Sample b | Talc | 10 | Δ |
| Example 2 | | | | |
| Comparative | Sample c | Mg(OH)₂ | 3 | Δ |
| Example 3 | | | | |
| Comparative | Sample d | Mg(OH)₂ | 4 | Δ |
| Example 4 | | | | |
| Comparative | Sample e | Mg(OH)₂ | 4 | Δ |
| Example 5 | | | | |
| Comparative | Sample f | Mg(OH)₂ | 3 | Δ |
| Example 6 | | | | |
| Comparative | Sample g | SiO₂ | 2 | X |
| Example 7 | | | | |

### Evaluation 4

### Measurement of Mechanical Physical Properties

Samples A through F obtained in Example 1 through 6 and Samples a and b were pelletized by the same method as that in Evaluation 2, and subsequently injection molding was carried out using an injection molding machine (Klockner F85 type; NSK Ltd., Japan) according to JIS K7152 to make multipurpose test pieces as defined in JIS K7139. Using the resultant test pieces, their tensile strength (JIS, K7113), elongation percentage (JIS K7113), flexural elasticity modulus (JIS K7203), IZOD impact value (JIS K7110), and thermal distortion temperature were measured according to respective JIS standards. The results are shown in Table 3.

TABLE 3

| | | | | Flexural | IZOD | Thermal |
|---|---|---|---|---|---|---|
| | | | Percent | elasticity | impact | distortion |
| | | Tensile | elongation | modulus | value | temperature |
| | | strength (Mpa) | (%) | (Mpa) | (Kj/m²) | (° C.) |
| Example 1 | Sample A | 28.3 | 45.9 | 2,640 | 8.4 | 134 |
| Example 2 | Sample B | 28.0 | 43.8 | 2,420 | 7.6 | 132 |
| Example 3 | Sample C | 27.1 | 45.9 | 2,300 | 7.2 | 131 |
| Example 4 | Sample D | 27.3 | 43.4 | 2,440 | 7.6 | 132 |
| Example 5 | Sample E | 28.1 | 40.0 | 2,570 | 7.5 | 134 |
| Example 6 | Sample F | 27.8 | 44.6 | 2,530 | 8.7 | 130 |
| Comparative | Sample a | 27.5 | 21.0 | 2,400 | 7.5 | 134 |
| Example 1 | | | | | | |
| Comparative | Sample b | 27.0 | 20.5 | 2,350 | 6.8 | 133 |
| Example 2 | | | | | | |

### Evaluation 5

### Evaluation of Flame Retardance

Samples G through J obtained in Example 7 through 10 and Samples c through f obtained in Example 3 to 6 were pelletized by the same method as that in Evaluation 2, and subsequently the oxygen index burning test by JIS K7201 and the burning test by UL standard (⅛ inch) were carried out. The results are shown in Table 4. Those which are higher in oxygen index are more flame retardant. The evaluation of flame retardance by UL standard is as follows:

Evaluation of flame retardance by UL standard:

(Superior) V-0>V-1>V-2 (Inferior)

TABLE 4

| | | Oxygen | UL |
|---|---|---|---|
| | | index | standard |
| Example 7 | Sample G | 26.0 | V-0 |
| Example 8 | Sample H | 26.0 | V-0 |
| Example 9 | Sample I | 26.0 | V-0 |
| Example 10 | Sample J | 26.0 | V-0 |
| Comparative | Sample c | 24.5 | V-2 |
| Example 1 | | | |
| Comparative | Sample d | 24.0 | V-2 |
| Example 4 | | | |
| Comparative | Sample e | 24.0 | V-2 |
| Example 5 | | | |
| Comparative | Sample f | 24.5 | V-1 |
| Example 6 | | | |

Samples K and L obtained in Example 11 and 12 and Sample g obtained in the comparative example 7 all exhibit excellent anti-blocking property.

As is obvious from Tables 2 through 4, because the granular inorganic filler of the invention is within the destruction rate ranges of 5 to 80% and the apparent density ranges of 0.1 to 3.0 g/ml, it can dramatically improve the production amount and provide excellent durability without impairing functionalities (such as mechanical physical properties, surface appearance, flame retardance and anti-blocking property) of the resin compositions.

### Industrial Applicability

As described herein above, the granular inorganic fillers of the invention composed of the inorganic filler particles and binder, said granular inorganic filler having an apparent density of 0.1 to 3.0 g/ml and a destruction rate of 5 to 80%, when the resin composition is made by use of such fillers, can dramatically enhance the production efficiency and remarkably improve economic efficiency. According to the granular inorganic fillers of the invention, it is possible to provide resin compositions which are excellent in mechanical physical properties, surface appearance, flame retardance and anti-blocking property.

While the present invention has been described specifically in detail with reference to certain embodiments and examples thereof, it would be apparent that it is possible to practice it in other forms. In light of the disclosure, it will be understood that various modifications and variations are within the spirit and scope of the appended claims. This application claims the benefit of Japanese Patent Application No. 2000-357562 (filed on Nov. 24, 2000) and Japanese Patent Application No. 2001-142036 (filed on May 11, 2001), both which serve as the basis for the right of priority, whose disclosures are hereby incorporated by reference.

What is claimed is:

1. A granular inorganic filler made up of inorganic filler particles having an average primary particle diameter of 0.01 to 20 μm and a binder, said granular inorganic filler having an apparent density of 0.1 to 3.0 g/ml and a destruction rate of 5 to 80% by weight.

2. The granular inorganic filler according to claim 1, wherein the filler contains the binder at 0.1 to 20% by weight.

3. The granular inorganic filler according to claim 1, wherein the binder is a clay mineral.

4. The granular inorganic filler according to claim 1, wherein the binder is bentonite.

5. The granular inorganic filler according to claim 1, having an average axis length of 0.5 to 5.0 mm and an axis ratio of 0.3 to 3.

6. The granular inorganic filler according to claim 1, wherein the filler contains a dispersing agent at 0.05 to 5% by weight.

7. The granular inorganic filler according to claim 6, wherein the dispersing agent is at least one or more members selected from the group consisting of alcohols, alkanol amines, organic silicone compounds, higher fatty acids, fatty acid matal salts, hydrocarbon lubricants, basic amino acids, polyglycerines and derivatives thereof.

8. The granular inorganic filler according to claim 1, wherein the inorganic filler particles are those treated with at least one or more members selected from the group consisting of alcohols, alkanol amines, organic silicone compounds, higher fatty acids, fatty acid metal salts, hydrocarbon lubricants, basic amino acids, polyglycerines and derivatives thereof as well as silane coupling agents, titanate coupling agents, and aluminium coupling agents.

9. A process for producing the granular inorganic filler according to claim 1, which comprises
adding a wetting agent to inorganic filler particles and a binder, and
molding the resultant mixture, and
then drying the molded product.

10. The process according to claim 9, wherein the wetting agent is added to the inorganic filler particles and the binder in combination with a dispersing agent, followed by molding and drying.

11. The process according to claim 9, wherein, while agitating the inorganic filler particles and the binder, the wetting agent is added to form a mixture and then the resultant mixture is molded.

12. The process according to claim 11, wherein, while agitating the inorganic filler particles, the binder and the dispersing agent, the wetting agent is added to form a mixture and the resultant mixture is molded.

13. The process according to claim 9, wherein the wetting agent is at least one member selected from water and alcohols.

14. The process according to claim 10, wherein the wetting agent is premixed with the dispersing agent.

15. The process according to claim 9, wherein the wetting agent is premixed with the binder.

16. The process according to claim 10, wherein the dispersing agent is premixed with the binder.

17. The process according to claim 9, wherein the wetting agent is added in an amount ranging from 10 to 150 parts by weight based on total inorganic filler particle+binder composition weight where the total weight of the inorganic filler particle plus the binder is set at 100 parts by weight.

18. A resin composition containing the granular inorganic filler according to claim 1.

19. The resin composition according to claim 18, wherein the resin comprises a main component selected from the group consisting of thermoplastic resins, thermosetting resins and formulations thereof.

20. The resin composition according to claim 18, wherein the resin comprises a main component selected from the group consisting of (1) polyethylene resins, polypropylene resins and polyolefin resins of ethylene-propylene copolymers, (2) polyester resins including polybutylene naphthalate, polyethylene terephthalate, polybutylene terephthalate and polyarylate, (3) stylene resins including acrylonitrile-butadiene-stylene copolymers and polystylene, (4) aromatic resins including poly(phenylene ether), polyetheretherketone resins, poly(phenylene sulfide), poly(ether sulfone)resins and polysulfone resins, (5) vinyl resins including vinyl chloride and vinyl acetate, (6) thermoplastic urethane resins, (7) nylon resins, (8) polyimide resins, (9) polyamideimide resins, (10) polyetherimide resins, (11) acrylic resins, (12) rubber resins, (13) fluorine resins, (14) polyacetal resins, (15) polycarbonate resins, (16) phenol resins, (17) thermosetting urethane resins, (18) unsaturated polyester resins and (19) formulations thereof.
